(19) United States
(12) Patent Application Publication
(10) Pub. No.: US 2025/0078173 A1
(43) Pub. Date: Mar. 6, 2025

(54) SYSTEM AND METHOD FOR ENHANCING SOCIAL INTERACTION AND COMMUNITY BUILDING

(71) Applicant: Krew Social Inc., Tampa, FL (US)

(72) Inventor: Michael Chahinian, Tampa, FL (US)

(73) Assignee: Krew Social Inc., Tampa, FL (US)

(21) Appl. No.: 18/823,557

(22) Filed: Sep. 3, 2024

Related U.S. Application Data
(60) Provisional application No. 63/535,960, filed on Aug. 31, 2023.

(51) Int. Cl. G06Q 50/00

(52) U.S. Cl. CPC G06Q 50/01

(57) ABSTRACT

A system may receive a user profile including user information; create one or more hangouts based on the user information; display the one or more hangouts on a map interface; receive a request to join one of the one or more exclusive hangouts from one of the one or more users; upon approval of the request, generate a virtual environment; create one or more suggested group activities; determine compatibility scores between a first user and one or more additional users; display to the first user one or more indicators identifying one or more of, the one or more additional users associated with a compatibility score which is above a compatibility score threshold.

### CROSS-REFERENCE TO RELATED APPLICATIONS

This application claims the benefit of U.S. Provisional Patent Application No. 63/535,960 filed on Aug. 31, 2023, which is incorporated by reference herein in its entirety.

### FIELD OF THE PRESENT DISCLOSURE

The invention relates in general to the field of digital social interaction and community building, and more specifically, to systems, methods, and devices for creating and managing hangouts based on user profiles, and more particularly, to a process for social interaction and community building

### BACKGROUND

Currently the state of the art includes a variety of social media sites and applications that are designed to promote social networking.

In the realm of digital social interaction and community building, various platforms and applications have been developed to facilitate communication and interaction among users. These platforms often rely on user profiles, which contain information about the user's interests, preferences, and other personal details. User profiles are typically used to personalize the user's experience on the platform, such as by recommending content or other users with similar interests.

One common feature of many social interaction platforms is the ability to create and join virtual spaces or “hangouts,” where users can interact with each other. These hangouts can be based on several factors, such as common interests or activities, and can be used for a variety of purposes, such as casual socializing, professional networking, or collaborative work.

Communication within these hangouts can take various forms, including text-based chat, voice chat, video chat, and more. Some platforms may also provide features to facilitate group activities within the hangout, such as shared screens for collaborative work or games for entertainment.

In addition to facilitating interaction among users, some platforms also provide features to manage the hangouts. For example, a user may be able to invite other users to join a hangout, approve or deny requests to join, and control various settings for the hangout.

Despite the variety of features and functionalities provided by existing platforms, the field of digital social interaction and community building continues to evolve, with ongoing developments in technology and changing user preferences and behaviors.

These and other objects, features, and advantages of the present disclosure will become more readily apparent from the attached drawings and the detailed description of the preferred embodiments, which follow.

### SUMMARY

Bearing in mind the problems and deficiencies of the prior art, it is therefore an object of the present disclosure to provide a process and system for social interaction and community building.

Aspects of the present disclosure relate to a system for identifying and facilitating virtual communication and networking, the system including: a device including at least one device processor, at least one device database, at least one device memory including computer-executable device instructions which, when executed by the at least one device processor, cause the device to: receive a user profile, via a user profile module, the user profile including user information, wherein the user information is included of at least one of one or more user interests, one or more user preferences, or membership to one or more private communities; create, via a hangout creation module, one or more hangouts based on the user information, wherein the one or more hangouts include at least one of one or more public hangouts, one or more exclusive hangouts, or one or more private hangouts, wherein the one or more exclusive hangouts restrict a user's ability to join the one or more exclusive hangouts, wherein each of the one or more private hangouts are associated to one or more private communities, and wherein the one or more private hangouts are configured to be accessible to users having membership to the one or more associated private communities or users invited to the one or more private hangouts by an organizing user; display, via a display module, the one or more hangouts on a map interface, wherein the map interface is configured to display a geographical representation of an approximate location of the one or more hangouts; receive, via a user request module, a request to join one of the one or more exclusive hangouts from one of the one or more users, upon approval of the request, generating a virtual environment, via a communication module; create, via a suggestion algorithm, one or more suggested group activities; determine, via a connection algorithm, compatibility scores between a first user and one or more additional users; and display to the first user one or more indicators identifying one or more of, the one or more additional users associated with a compatibility score which is above a compatibility score threshold.

Aspects of the present disclosure relate to a system, wherein the suggestion algorithm is a machine learning algorithm including a computer-implemented method including: receiving an input dataset including, at least one of a user's historical communication data and the user information; predicting, the one or more suggested group activities, that one of the one or more users is likely to attend based on the input dataset; and producing, an output dataset including the one or more suggested group activities, that one of the one or more users is likely to attend.

Aspects of the present disclosure relate to a system, wherein the connection algorithm is a machine learning algorithm including a computer-implemented method including: receiving an input dataset including, user information of a plurality of user profiles; determining a similarity between the user information of a first user and the user information of the one or more additional users; and producing, an output dataset including the compatibility score of the first user and the one or more additional users.

Aspects of the present disclosure relate to a system, wherein the virtual environment is a chat facilitating real-time communication amongst the one or more users.

Aspects of the present disclosure relate to a system, wherein the one of one or more user interests and one or more user preferences include at least one of: outdoor activities, indoor activities, sports, religion, and education.

Aspects of the present disclosure relate to a system, wherein the computer-executable device instructions which, when executed by the at least one device processor, further cause the device to: send, via a smart invite algorithm, invites to one or more suggested users that are likely to attend the one or more hangouts, the invites corresponding to the one or more hangouts.

Aspects of the present disclosure relate to a system, wherein the smart invite algorithm is a machine learning algorithm including a computer-implemented method including: receiving an input dataset including, user information of a plurality of user profiles; predicting the one or more suggested users that are likely to attend the one or more hangouts; and producing an output dataset including the one or more suggested users.

Aspects of the present disclosure relate to a system, wherein the computer-executable device instructions which, when executed by the at least one device processor, further cause the device to: enable, via a contextual invite system, a first user to invite a second user to join one of the one or more hangouts.

Aspects of the present disclosure relate to a system, wherein the contextual invite system is based on at least one of a proximity to the first user and a community membership of the second user.

Aspects of the present disclosure relate to a computer-implemented method for identifying and facilitating virtual communication and networking, wherein each of the following steps are performed by one or more computer components, the computer-implemented method including: receiving, via a user profile module, a user profile, the user profile including user information, wherein the user information is included of at least one of one or more user interests, one or more user preferences, or membership to one or more private communities; creating, via a hangout creation module, one or more hangouts based on the user information, wherein the one or more hangouts include at least one of one or more public hangouts, one or more exclusive hangouts, or one or more private hangouts, wherein the one or more exclusive hangouts restrict a user's ability to join the one or more exclusive hangouts, wherein each of the one or more private hangouts are associated to one or more private communities, and wherein the one or more private hangouts are configured to be accessible to users having membership to the one or more associated private communities or users invited to the one or more private hangouts by an organizing user; displaying, via a display module, the one or more hangouts on a map interface, wherein the map interface is configured to display a geographical representation of an approximate location of the one or more hangouts; receiving, via a user request module, a request to join one of the one or more exclusive hangouts from one of the one or more users, upon approval of the request, generating a virtual environment, via a communication module; creating, via a suggestion algorithm, one or more suggested group activities; determining, via a connection algorithm, compatibility scores between a first user and one or more additional users; and displaying to the first user one or more indicators identifying one or more of, the one or more additional users associated with a compatibility score which is above a compatibility score threshold.

Aspects of the present disclosure relate to a computer-implemented method, wherein the suggestion algorithm is a machine learning algorithm including a computer-implemented method including: receiving an input dataset including, at least one of a user's historical communication data and the user information; predicting, the one or more suggested group activities, that one of the one or more users is likely to attend based on the input dataset; and producing, an output dataset including the one or more suggested group activities, that one of the one or more users is likely to attend.

Aspects of the present disclosure relate to a computer-implemented method, wherein the connection algorithm is a machine learning algorithm including a computer-implemented method including: receiving an input dataset including, user information of a plurality of user profiles; determining a similarity between the user information of a first user and the user information of the one or more additional users; and producing, an output dataset including the compatibility score of the first user and the one or more additional users.

Aspects of the present disclosure relate to a computer-implemented method, further including: sending, via a smart invite algorithm, invites to one or more suggested users that are likely to attend the one or more hangouts, the invites corresponding to the one or more hangouts.

Aspects of the present disclosure relate to a computer-implemented method, wherein the smart invite algorithm is a machine learning algorithm including a computer-implemented method including: receiving an input dataset including, user information of a plurality of user profiles; predicting the one or more suggested users that are likely to attend the one or more hangouts; and producing an output dataset including the one or more suggested users.

Aspects of the present disclosure relate to a non-transitory computer readable medium having a set of instructions stored thereon that, when executed by a processing device, cause the processing device to carry out an operation, the operation including the steps of: receiving, via a user profile module, a user profile, the user profile including user information, wherein the user information is included of at least one of one or more user interests, one or more user preferences, or membership to one or more private communities; creating, via a hangout creation module, one or more hangouts based on the user information, wherein the one or more hangouts include at least one of one or more public hangouts, one or more exclusive hangouts, or one or more private hangouts, wherein the one or more exclusive hangouts restrict a user's ability to join the one or more exclusive hangouts, wherein each of the one or more private hangouts are associated to one or more private communities, and wherein the one or more private hangouts are configured to be accessible to users having membership to the one or more associated private communities or users invited to the one or more private hangouts by an organizing user; displaying, via a display module, the one or more hangouts on a map interface, wherein the map interface is configured to display a geographical representation of an approximate location of the one or more hangouts; receiving, via a user request module, a request to join one of the one or more exclusive hangouts from one of the one or more users, upon approval of the request, generating a virtual environment, via a communication module; creating, via a suggestion algorithm, one or more suggested group activities; determining, via a connection algorithm, compatibility scores between a first user and one or more additional users; and displaying to the first user one or more indicators identifying one or more of, the one or more additional users associated with a compatibility score which is above a compatibility score threshold.

Aspects of the present disclosure relate to a non-transitory computer readable medium, wherein the suggestion algorithm is a machine learning algorithm including a computer-implemented method including: receiving an input dataset including, at least one of a user's historical communication data and the user information; predicting, the one or more suggested group activities, that one of the one or more users is likely to attend based on the input dataset; and producing, an output dataset including the one or more suggested group activities, that one of the one or more users is likely to attend.

Aspects of the present disclosure relate to a non-transitory computer readable medium, wherein the connection algorithm is a machine learning algorithm including a computer-implemented method including: receiving an input dataset including, user information of a plurality of user profiles; determining a similarity between the user information of a first user and the user information of the one or more additional users; and producing, an output dataset including the compatibility score of the first user and the one or more additional users.

Aspects of the present disclosure relate to a non-transitory computer readable medium, further including the step of: sending, via a smart invite algorithm, invites to one or more suggested users that are likely to attend the one or more hangouts, the invites corresponding to the one or more hangouts.

Aspects of the present disclosure relate to a non-transitory computer readable medium, wherein the smart invite algorithm is a machine learning algorithm including a computer-implemented method including: receiving an input dataset including, user information of a plurality of user profiles; predicting the one or more suggested users that are likely to attend the one or more hangouts; and producing an output dataset including the one or more suggested users.

Aspects of the present disclosure relate to a non-transitory computer readable medium, wherein the virtual environment is a chat facilitating real-time communication amongst the one or more users.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is an illustrative block diagram of a system based on a computer according to aspects of the present disclosure;

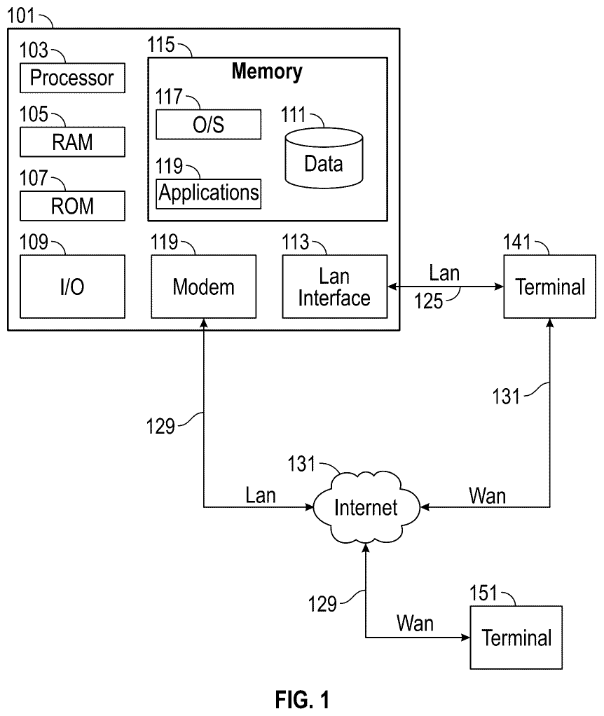

FIG. 2 is an illustration of a computing machine according to aspects of the present disclosure;

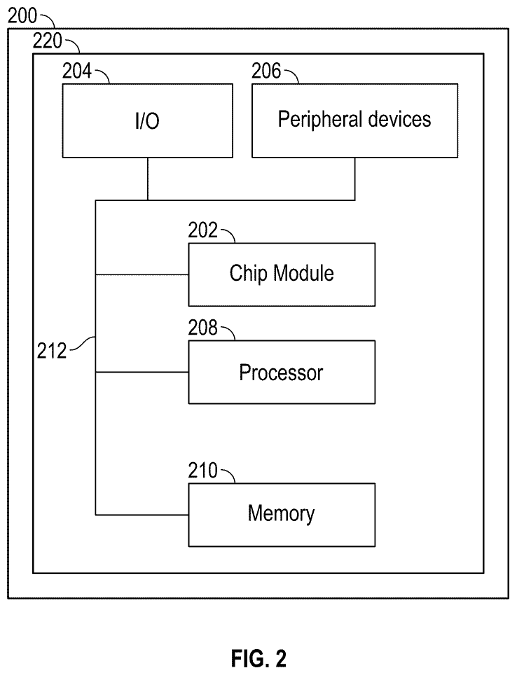

FIG. 3 is a flow chart showing how a user would use the system according to aspects of the present disclosure;

FIG. 4 is a flow chart showing how the organizer of the hangout would use the system according to aspects of the present disclosure;

FIG. 5 is a screenshot of the mobile application showing how a user creates a profile according to aspects of the present disclosure;

FIG. 6 is a screenshot of the mobile application showing how a user creates a hangout and check out other hangouts according to aspects of the present disclosure;

FIG. 7 is a screen shoot of the mobile application showing a hangout and how to check who's going to a hangout according to aspects of the present disclosure;

FIG. 8 is a screenshot of the mobile application showing how to create a hangout and select the activity that the user wants to do according to aspects of the present disclosure;

FIG. 9 is a screenshot of the mobile application showing how a user can look up new members and chat with other members of a hangout according to aspects of the present disclosure;

FIG. 10 is a screenshot of the mobile application showing how a user can add new friends to create a custom circle of friends within hangout according to aspects of the present disclosure;

FIG. 11 is a screenshot of the mobile application showing how the display of hangouts to user according to aspects of the present disclosure; and

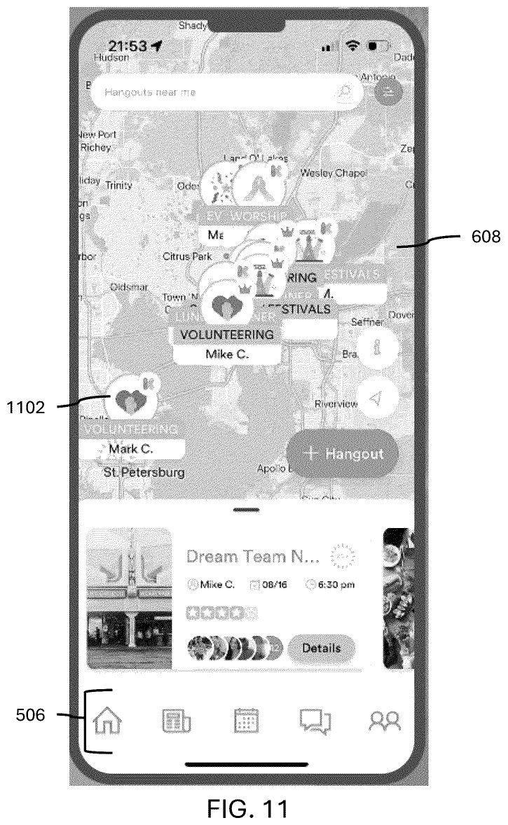

FIG. 12 is a screenshot of the mobile application showing information associated with a hangout according to aspects of the present disclosure.

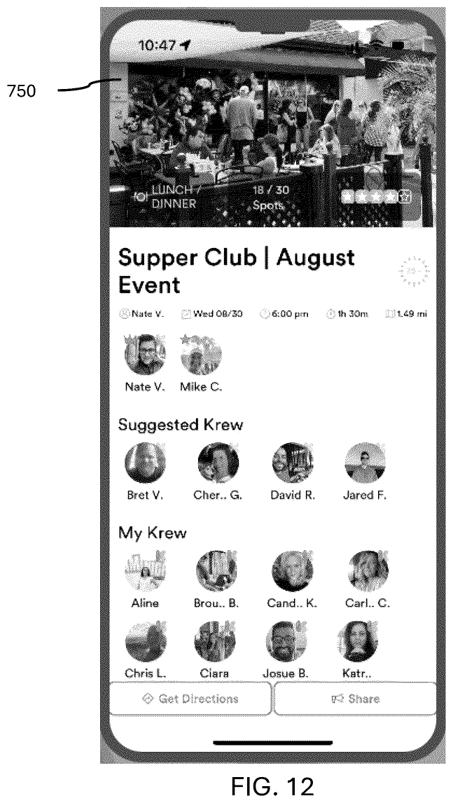

FIG. 13 is an illustrative block diagram of a method for creating and coordinating hangouts according to aspects of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms hangout and website can be used interchangeably within the application or process and is meant to mean a private or public website where users can have or schedule social interaction.

Prior to a discussion of the preferred embodiment of the invention, it should be understood that while the features and advantages of the invention are illustrated in terms of a computerized system that many of the process and techniques can be used or implemented with or without a computer.

The following description sets forth exemplary aspects of the present disclosure. It should be recognized, however, that such a description is not intended as a limitation on the scope of the present disclosure. Rather, the description also encompasses combinations and modifications to those exemplary aspects described herein.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer and/or storage device via the network and download part or all of a software application or data and may execute any computer-executable instructions. Alternatively, the local computer may download pieces of the software or data as needed or process the software in a distributive manner by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium,” “computer-readable media,” and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, wearable devices, one or more servers, network services such as an Internet services or corporate network services based on one or more computers, and the like, and/or any combination thereof. Thus, a computing device, as the term is used herein, is also intended to be and must be interpreted as statutory subject matter.

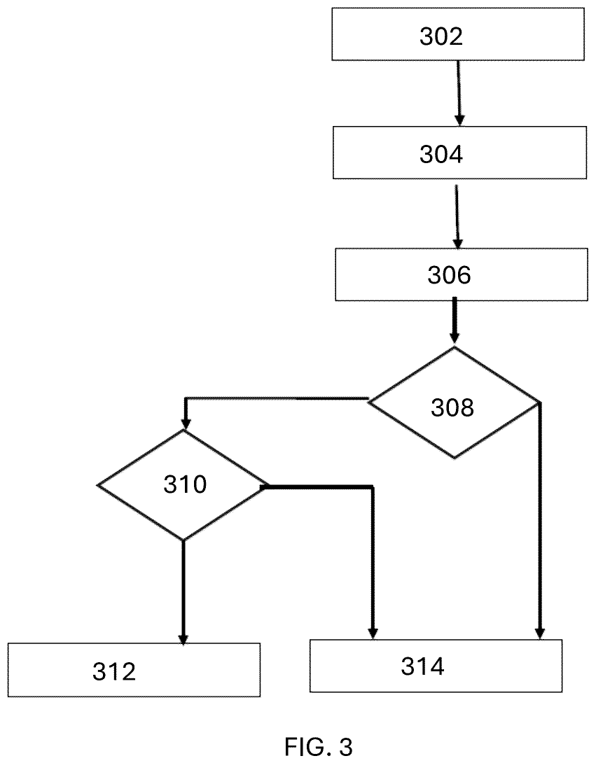

FIG. 3 is an illustrative block diagram of a system 100 based on a computer 101. The computer 101 may have a processor 103 for controlling the operation of the device and its associated components, and may include RAM 105, ROM 107, input/output module 109, and a memory 115. The processor 103 will also execute all software running on the computer (e.g., the operating system). Other components commonly used for computers such as EEPROM or Flash memory or any other suitable components may also be part of the computer 101.

The memory 115 may be comprised of any suitable permanent storage technology (e.g., a hard drive). The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input and may also include one or more speakers for providing audio output and a video display device for providing textual, audiovisual and/or graphical output.

The system 100 may be connected to other systems via a LAN interface 113.

Furthermore, the system 100 may operate in a networked environment supporting connections to one or more remote computers, such as terminals 141 and 151. The terminals 141 and 151 may be personal computers or servers that include many or all of the elements described above relative to system 100. The network connections depicted in FIG. 3 include a local area network (LAN) 325 and a wide area network (WAN) 329, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of the various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

The computer 101 and/or terminals 141 or 151 may also be devices including various other components, such as a battery, speaker, and antennas (not shown).

At least one of terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

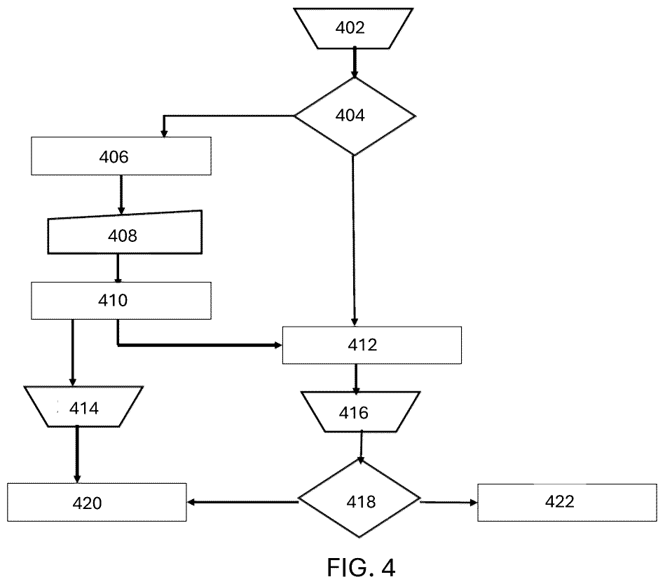

FIG. 4 shows illustrative apparatus 200. The apparatus 200 may be a computing machine. The apparatus 200 may include one or more features of the apparatus shown in FIG. 3. The apparatus 200 may include a chip module 202, which may include one or more integrated circuits, and which may include logic configured to perform any other suitable logical operations.

Apparatus 200 may include one or more of the following components: I/O circuitry 204, which may include a transmitter device and/or a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which he may hold, the current time, information pertaining to historical user account activity and/or any other suitable information or data structures.

Components 202, 204, 206, 208 and 210 may be coupled together by a system bus or other interconnections 212 and may be present on one or more circuit boards such as 420. In some embodiments, the components may be integrated into a single chip. The chip may be silicon-based.

The present disclosure pertains to the field of digital social interaction and community building, specifically to systems, methods, and devices for creating and managing hangouts based on user profiles. In some aspects, the present disclosure provides a software application that can be executed on a mobile device or other computer system, allowing users to create a hangout that other team members or associated individuals can join to promote team interaction and communication. The present disclosure may further provide a software application that generates and facilitates private communities.

In some cases, the application may receive a user profile and create a hangout based on the information in the user profile. The hangout may then be displayed, and the application may receive a request from a user to join the hangout. Based on the user profile, the user will see, in addition to public hangouts, certain private hangouts dependent on the user's membership to one or more private communities.

Upon approval of the user request, the application may enable communication within the hangout. This may be achieved by automatically creating and/or adding users within a hangout to a group chat feature within the application. This approach may facilitate social interaction and community building by providing a platform for users to interact and communicate in a virtual environment.

In some embodiments, the application may suggest group activities based on common interests identified in the user profile. These group activities may be suggested by an algorithm, providing a personalized experience for each user. In other embodiments, the application may enable a user to invite other users to join the hangout.

The other users may be selected based on a contextual invite system. The contextual invite system may limit the available users, a specific user may invite to a hangout. For example, a first user may be able to invite one or more additional users based on said additional users' proximity to the first user or their membership in a specific team or private community, further enhancing the social interaction and community building aspects of the application.

Private communities may be related to certain businesses or groups. Examples of such private communities include business organizations, religious groups, groups identifying as a certain gender, groups of certain age ranges, or any other suitable group of shared characteristics.

In yet other embodiments, the application may automatically create a chat for the hangout within the virtual environment, thus facilitating communication amongst the users. The hangout may be displayed on a map interface, providing a visual representation 1102 of an approximation of a hangout location. These features may enhance the user experience and promote social interaction and community building.

The systems, methods, and devices disclosed herein may address the technical problems present in the field of digital social interaction and community building, such as the lack of social wellness software to build community for individuals and enterprises. By providing a platform for users to interact and communicate in both a physical and virtual environment, the present disclosure may enhance social interaction and community building, thereby addressing these technical problems.

In some aspects, software applications for enhancing social interaction and community building may be executed on a mobile device or other computer system. The application may be designed to facilitate the creation of a hangout, which may be at least one of a physical location or a virtual space where users can interact and communicate with each other. The hangout may be created based on a user profile, which may include information about the user's interests, preferences, and other personal details. The user profile may be received by the application, and the hangout may be created accordingly.

In some cases, the application may suggest group activities for the hangout based on common interests identified in the user profile such as reading, religion, rock climbing, surfing, board games, or any other interests the user may have. The user may select interests from a predefined list or, in an embodiment, may input their own interests. The common interests may be determined based on the information provided in the user profile, and the group activities may be suggested accordingly. This feature may facilitate social interaction and community building by providing a platform for users to engage in activities that they enjoy and have in common with other users.

In some embodiments, the group activities may be suggested by an algorithm configured to associate certain interests with corresponding activities. The algorithm may analyze the information in the user profile and suggest group activities based on the common interests identified. The algorithm may be designed to provide personalized suggestions for each user, enhancing the user experience and promoting social interaction and community building. The suggested group activities may be displayed to the user, and the user may choose to participate in the suggested activities.

In certain aspects of the present disclosure, the algorithm for suggesting group activities may be a machine learning algorithm. Such an algorithm may receive an input of data including group activity attendance and the interests of the attending users and subsequently determine which group activities users with certain interests are most likely to attend.

In some cases, the application may enable the user to invite other users to join the hangout. The other users may be selected based on their proximity to the user or their membership in a specific team. This feature may further enhance the social interaction and community building aspects of the application by facilitating interaction among users who are in close proximity or who are part of the same team.

In yet other embodiments, the application may automatically create a chat for the hangout within the virtual environment. The chat may facilitate communication among the users in the hangout, promoting social interaction and community building. The hangout, including the chat, may be displayed on a map interface, providing a visual representation 1102 of the hangout location. In an embodiment, the hangout location may be represented by a general area rather than a specific point to enhance safety. Once a user joins a hangout, the visual representation 1102 of the hangout location may then indicate the exact location of that hangout. This feature may enhance the user experience and promote social interaction and community building by providing a visual representation 1102 of the hangout and facilitating communication among the users.

In some aspects, the process of enhancing social interaction and community building may begin with the application receiving a user profile. The user profile may include several types of information about the user, such as the user's interests, preferences, and other personal details. This information may be used to personalize the user's experience on the application and to facilitate the creation of a hangout that aligns with the user's interests and preferences.

In some cases, the application may create a hangout based on the user profile. The hangout may be either a physical location or a virtual space where users can interact and communicate with each other. The creation of the hangout may be based on the information provided in the user profile, such as the user's interests and preferences. For example, if the user profile indicates that the user is interested in hiking, the application may create a hangout for a hiking activity. This approach may facilitate social interaction and community building by providing a platform for users to engage in activities that they enjoy and have in common with other users.

In some embodiments, the user profile may include user interests and preferences. These interests and preferences may be used to personalize the user's experience on the application and to facilitate the creation of a hangout that aligns with the user's interests and preferences. For example, if the user profile indicates that the user is interested in hiking and prefers outdoor activities, the application may create a hangout for a hiking activity in an outdoor location.

In aspects of the present disclosure, a user may be prevented from creating a hangout based on the age of the user's account. For example, a user who has had an account for less than 1 month may be denied the ability to create hangouts until after the 1-month period. This functionality enables the user to familiarize themselves with the application before being exposed to increased functionality and complexity.

In other cases, hangouts may be created based on the user interests and preferences. The creation of the hangout may be based on the user's interests and preferences, as indicated in the user profile. This approach may facilitate social interaction and community building by providing a platform for users to engage in activities that align with their interests and preferences.

In an embodiment, a user may configure a hangout to be recurring. For example, a user may configure a virtual hangout to repeat every first Wednesday of a month, weekly on a Thursday, or any other suitable schedule.

To prevent every recurring hangout event being displayed (as discussed below) to the user at once, each subsequent hangout may be generated upon expiration of the preceding hangout.

In some aspects, the application may display the hangout to the user. The display of the hangout may provide a visual representation 1102 of the hangout, including information about the hangout such as the type of activity, the location, the time, and the participants. The display of the hangout may enhance the user experience by providing a visual overview of the hangout and facilitating the user's understanding and navigation of the hangout.

In some cases, the application may display the hangout on a map interface. The map interface 608 may provide a geographical representation 1102 of the location of the hangout, allowing the user to visually understand the location of the hangout in relation to other locations. The map interface may also display other hangouts in the vicinity, providing the user with a broader view of the available hangouts. In an embodiment, the hangouts shown to a user may be based on a predetermined proximity to the user's location (e.g., 20 miles). In another embodiment, the proximity restriction on displayed hangouts may only apply to public hangouts. As a non-limiting example, hangouts belonging to a private community, to which the user is a member, may be displayed on the map regardless of proximity to the user. This feature may enhance the user experience by providing a visual and geographical context for the hangout, facilitating the user's decision-making process in joining a hangout.

In some embodiments, the application may receive a request from a user to join the hangout. The user may send a request to join the hangout through the application, and the application may receive and process the request. Upon receiving the request, the application may notify the organizer of the hangout, who may then approve or deny the request. This process may facilitate social interaction and community building by allowing users to join hangouts that align with their interests and preferences.

In other cases, the group activities suggested for the hangout may be displayed on the map interface 608. The map interface may provide a geographical representation 1102 of the locations of the group activities, allowing the user to visually understand the locations of the activities in relation to other locations. The map interface may also display other group activities in the vicinity, providing the user with a broader view of the available activities. This feature may enhance the user experience by providing a visual and geographical context for the group activities, facilitating the user's decision-making process in participating in an activity.

Upon receiving a request from a user to join the hangout, the application may process the request and notify the organizer of the hangout. In some aspects, the organizer may have the authority to approve or deny the user's request to join the hangout. This approval process may serve as a mechanism to ensure that the users joining the hangout align with the interests and preferences of the group, thereby promoting a harmonious and engaging social interaction within the hangout.

Once the user's request to join the hangout is approved, the application may enable communication within the hangout. In some cases, this communication may take the form of a chat feature within the application. The chat feature may allow users to send and receive messages in real-time, facilitating interaction and discussion among the users in the hangout. This feature may enhance the social interaction and community building aspects of the application by providing a platform for users to communicate and interact with each other in a virtual environment.

In some embodiments, the application may automatically create a chat for the hangout upon approval of the user's request to join. This automatic creation of a chat may streamline the process of setting up communication within the hangout, enhancing the user experience and promoting efficient social interaction. The chat may be associated with the specific hangout, allowing users to engage in focused discussions related to the hangout's activities or interests.

In other cases, the communication module of the application may be further configured to automatically create a chat for the hangout. This automatic creation of a chat may be facilitated by the communication module, which may be designed to handle various communication-related functionalities within the application. The communication module may create a chat for the hangout upon approval of the user's request to join, providing a ready-to-use platform for users to communicate and interact within the hangout. This feature may enhance the user experience by providing a seamless transition from joining the hangout to participating in the hangout's communication and activities.

In some aspects, the application may suggest group activities for the hangout based on common interests identified in the user profile. These common interests may be determined based on the information provided in the user profile, and the group activities may be suggested accordingly. This feature may facilitate social interaction and community building by providing a platform for users to engage in activities that they enjoy and have in common with other users.

In some embodiments, the group activities may be suggested by an algorithm. The algorithm may analyze the information in the user profile and suggest group activities based on the common interests identified. The algorithm may be designed to provide personalized suggestions for each user, enhancing the user experience and promoting social interaction and community building. The suggested group activities may be displayed to the user, and the user may choose to participate in the suggested activities.

The suggested group activities may be generated via a machine learning algorithm. The machine learning algorithm may include a computer-implemented method including receiving an input dataset comprising interests of users and attendance of such users at group activities; predicting group activities a specific user is likely to attend based on the interests of users and attendance of such users at group activities; and producing an output dataset comprising suggested group activities the specific user is likely to attend.

In some cases, the application may enable a user to invite other users to join the hangout. The other users may be selected based on their proximity to the user or their membership in a specific team. This feature may further enhance the social interaction and community building aspects of the application by facilitating interaction among users who are in close proximity or who are part of the same team. The application may provide the user with a list of other users who are in close proximity or who are part of the same team, and the user may select from this list to invite other users to join the hangout.

In other embodiments, the application may automatically create a chat for the hangout. The chat may facilitate communication among the users in the hangout, promoting social interaction and community building. The hangout, including the chat, may be displayed on a map interface 608, providing a visual representation 1102 of the hangout location. This feature may enhance the user experience and promote social interaction and community building by providing a visual representation of the hangout and facilitating communication among the users.

In some aspects, the application may include a user request module configured to receive a request from a user to invite other users to join the hangout. This feature may allow a user to extend an invitation to other users, thereby promoting social interaction and community building. The user request module may process the invitation request and notify the invited users, providing them with the option to join the hangout.

In some cases, the selection of other users to be invited may be based on their proximity to the user or their membership in a specific team (i.e., one or more private communities). For instance, the application may include a proximity detection feature that identifies other users who are in close geographical proximity to the user. This feature may be particularly useful for organizing local events or activities, where participants are expected to be in the same geographical area.

In other cases, the selection of other users may be based on their membership in a specific team. For example, if the user is part of a sports team, a work team, or any other group, the application may allow the user to invite other members of the same team to join the hangout. This feature may facilitate team interaction and communication, promoting team cohesion and collaboration.

In some embodiments, the application may include a notification feature that notifies the invited users about the invitation to join the hangout. The notification may include details about the hangout, such as the type of activity, the time, and the location. Upon receiving the notification, the invited users may choose to accept or decline the invitation.

In various aspects of the present disclosure, a user may be alerted of a hangout they have been invited and/or is starting soon (e.g., within 1 hour).

In other embodiments, the application may include a communication module configured to enable communication within the hangout upon approval of the user request. The communication module may facilitate various forms of communication, such as text-based chat, voice chat, video chat, and more. This feature may enhance the social interaction and community building aspects of the application by providing a platform for users to communicate and interact with each other in a virtual environment.

The chat created by the communication module may facilitate real-time communication among the users in the hangout. Users may be able to send and receive messages within the chat, allowing them to engage in discussions, share information, and coordinate activities. This feature may enhance the user experience by providing a convenient and efficient means of communication within the hangout.

In some cases, the hangout, including the chat, may be displayed on a map interface. The map interface may provide a visual representation of the location of the hangout, enhancing the user's understanding of the geographical context of the hangout. The map interface may also display other hangouts in the vicinity, providing the user with a broader view of the available hangouts. This feature may enhance the user experience by providing a visual and geographical context for the hangout, facilitating the user's decision-making process in joining a hangout.

In some embodiments, the user profile module within the application may be further configured to receive user interests and preferences. These interests and preferences may be used to personalize the user's experience on the application and to facilitate the creation of a hangout that aligns with the user's interests and preferences. For example, if the user profile indicates that the user is interested in hiking and prefers outdoor activities, the application may create a hangout for a hiking activity in an outdoor location. As a further non-limiting example, the application may display which hangouts include at least one person sharing a majority of interests with the user. Such a feature may be displayed as a faded “K” badge on the hangout geographical indicator.

In other cases, the hangout creation module within the application may be further configured to suggest group activities based on the user interests and preferences. The group activities may be suggested by an algorithm that analyzes the user's interests and preferences and suggests activities that align with these interests and preferences. The suggested group activities may be displayed on the display module, providing the user with a list of potential activities to participate in.

In some aspects, the suggested group activities may also be displayed on the map interface. The map interface may provide a geographical representation of the locations of the group activities, allowing the user to visually understand the locations of the activities in relation to other locations. The map interface may also display other group activities in the vicinity, providing the user with a broader view of the available activities. This feature may enhance the user experience by providing a visual and geographical context for the group activities, facilitating the user's decision-making process in participating in an activity.

In some aspects, the application may suggest group activities for inclusion in the hangout. These group activities may be suggested based on the common interests and preferences identified in the user profile. For instance, if the user profile indicates that the user enjoys outdoor activities such as hiking or cycling, the application may suggest group activities related to these interests. This feature may enhance the user experience by providing personalized activity suggestions that align with the user's interests and preferences, thereby promoting social interaction and community building.

In some cases, the suggested group activities may be displayed on a map interface within the application. The map interface may provide a visual representation 1102 of the geographical locations of the suggested group activities. For example, if a suggested group activity is a hiking trip, the map interface may display the location of the hiking trail. This feature may enhance the user experience by providing a visual and geographical context for the suggested group activities, facilitating the user's decision-making process in selecting an activity to participate in.

In some embodiments, the application may automatically create a chat for the hangout. This chat may be created upon approval of a user's request to join the hangout. The chat may serve as a platform for users within the hangout to communicate and interact with each other. For instance, users may use the chat to discuss the details of the group activities, share relevant information, or simply engage in casual conversation. This feature may enhance the social interaction and community building aspects of the application by providing a convenient and efficient means of communication within the hangout.

In other cases, the communication within the hangout may include an automatically created chat for the hangout. This chat may be created by the communication module of the application upon approval of a user's request to join the hangout. The chat may facilitate real-time communication among the users in the hangout, allowing them to engage in discussions, coordinate activities, or share information. This feature may enhance the user experience by providing a seamless platform for communication within the virtual hangout, thereby promoting social interaction and community building.

The application may include one or more chatbots occupying one or more communication channels accessible by the user. The communication between the user and chatbots may be stored in a communication database. The chatbots may be configured, via at least one or more algorithms, to assist the user with various functions described herein. For example, the user could communicate to the chatbot that they would like to create a hangout along with parameters of the hangout. Using the functions described herein, the chatbot may then create the hangout according to the user's specified parameters. As another non-limiting example, the chatbot may assist by suggesting hangouts and activities based on the functions described herein such as via a machine learning algorithm. The chatbots may be integrated into one or more chats created via the communication module, such that any user has the choice of whether to interact with another user in the chat, or directly with the one or more chatbots.

In an embodiment, the chatbots utilize generative artificial intelligence to formulate responses to user inputs. Such generative artificial intelligence may be based on a natural language model.

Moreover, the present disclosure may be further described as a system for identifying and facilitating virtual communication and networking. Such a system may comprise a device, wherein said device includes at least one of at least one device processor, at least one device database, and at least one device memory comprising computer-executable device instructions. In an embodiment, the computer-executable device instructions may be executed by the at least one device processor. In another embodiment, said execution of the computer-executable device instructions may cause the device to receive a user profile, via a user profile module. In an embodiment, the user profile may include user information, wherein said information includes at least one of one or more user interests, one or more user preferences, or membership to one or more private communities.

Additionally, the device, upon execution of the computer-executable device instructions, may create, via a hangout creation module, one or more hangouts based on the user information. In such an embodiment, the one or more hangouts include at least one of one or more public hangouts, one or more exclusive hangouts, or one or more private hangouts, wherein the one or more exclusive hangouts restrict a user's ability to join the one or more exclusive hangouts. Moreover, each of the one or more private hangouts are associated to one or more private communities. Furthermore, the one or more private hangouts may be configured to be accessible to users having membership to the one or more associated private communities or users invited to the one or more private hangouts by an organizing user.

In another embodiment, execution of the computer-executable device instructions may cause the device to display, via a display module, the one or more hangouts on a map interface. In such an embodiment, the map interface may be configured to display a geographical representation of an approximate location of the one or more hangouts.

Furthermore, execution of the computer-executable device instructions may cause the device to receive, via a user request module, a request to join one of the one or more hangouts from one of the one or more users. Additionally, upon approval of the request, generating a virtual environment, via a communication module.

In a further embodiment, the execution of the computer-executable device instructions may cause the device to create, via a suggestion algorithm, one or more suggested group activities.

In yet a further embodiment, execution of the computer-executable device instructions may cause the device to determine, via a connection algorithm, compatibility scores between a first user and one or more additional users.

Moreover, execution of the computer-executable device instructions may cause the device to display to the first user one or more indicators identifying one or more of, the one or more additional users associated with a compatibility score which is above a compatibility score threshold.

In an embodiment, the suggestion algorithm may be comprised of a machine learning algorithm. In such an embodiment, the machine learning algorithm may include a computer-implemented method. In a first step of the computer implemented method, the machine learning algorithm may receive an input dataset, wherein said dataset includes at least one of a user's historical communication data and the aforesaid user information. In a second step, the machine learning algorithm may predict the one or more suggested group activities, that one of the one or more users is likely to attend based on the input dataset. In a third step, the machine learning algorithm may produce an output dataset comprising the one or more suggested group activities, that one of the one or more users is likely to attend.

In an embodiment, the connection algorithm may include a machine learning algorithm, said algorithm including a computer-implemented method. The first step of the method may include, receiving an input dataset which may include user information of a plurality of user profiles. A second step of the method may, determine a similarity between the user information of a first user and the user information of the one or more additional users. Moreover, a third step of the method may produce an output dataset including the compatibility score of the first user and the one or more additional users.

In a further embodiment, the virtual environment may be comprised of a chat facilitating real-time communication amongst the one or more users. Moreover, the one of one or more user interests and one or more user preferences include at least one of: the one of one or more user interests and one or more user preferences include at least one of: outdoor activities (e.g., hiking, skiing, running, etc.), indoor activities (e.g., cooking, reading, watching movies, etc.), sports, religion, and education.

In an embodiment, the computer-executable device instructions which, when executed by the at least one device processor, may further cause the device to send, via a smart invite algorithm, invites to one or more suggested users that are likely to attend the one or more hangouts, the invites corresponding to the one or more hangouts. In such an embodiment, the smart invite algorithm may be comprised of a machine learning algorithm which may include a computer-implemented method. The method may include, a first step, wherein an input dataset is received, said dataset including user information of a plurality of user profiles. In a second step, the method may predict the one or more suggested users that are likely to attend the one or more hangouts. Furthermore, in a third step of the method, an output dataset may be produced, wherein the output dataset may include the one or more suggested users.

Additionally, the computer-executable device instructions which, when executed by the at least one device processor, may further cause the device to enable, via a contextual invite system, a first user to invite a second user to join one of the one or more hangouts.

In another embodiment, the contextual invite system may be based on at least one of a proximity to the first user and a community membership of the second user.

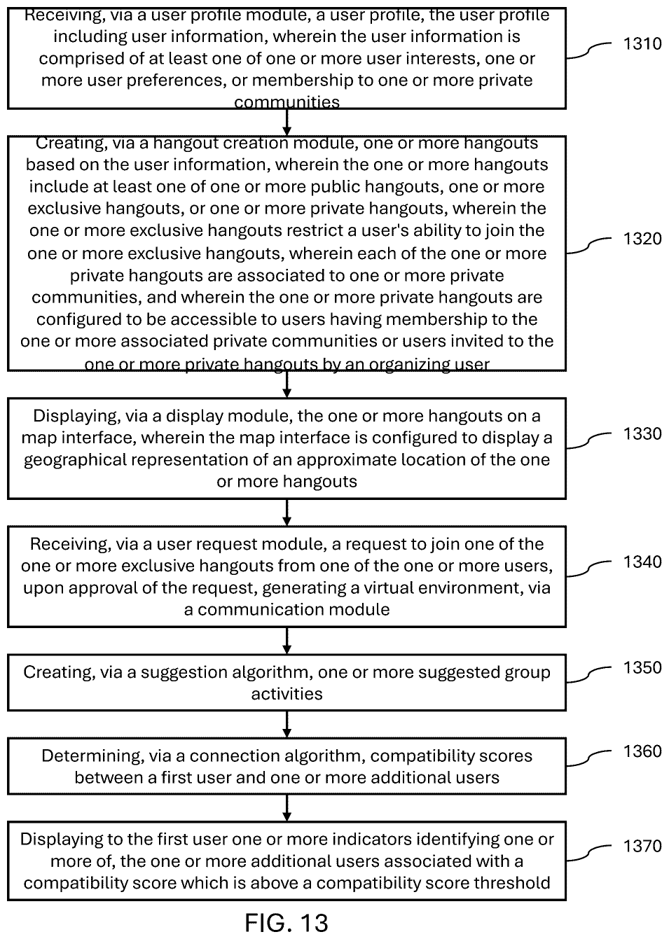

Additionally, turning to FIG. 13, the present disclosure may be further described as a computer-implemented method for identifying and facilitating virtual communication and networking. In an embodiment, the steps comprising the method may be performed by one or more computer components.

In an embodiment, the aforementioned method may be comprised of a first step 1310, wherein in said first step 1310, a user profile is received, via a user profile module. As a nonlimiting example, the user profile may include user information, wherein said information is comprised of at least one of one or more user interests, one or more user preferences, or membership to one or more private communities.

Moreover, the method may be further comprised of a second step 1320, wherein one or more hangouts are created, via a hangout creation module, based on the user information. In an example, the one or more hangouts include at least one of one or more public hangouts, one or more exclusive hangouts, or one or more private hangouts. In a further embodiment, the one or more exclusive hangouts may restrict a user's ability to join the one or more exclusive hangouts. In yet a further embodiment, each of the one or more private hangouts may be associated to one or more private communities. Moreover, the one or more private hangouts may also be configured to be accessible to users having membership to the one or more associated private communities.

A third step 1330 of the method may include, displaying, via a display module, the one or more hangouts on a map interface. As a further nonlimiting example, the map interface may be configured to display a geographical representation of an approximate location of the one or more hangouts.

Furthermore, the method may be additionally comprised of a fourth step 1340, wherein a request to join one of the one or more exclusive hangouts from one of the one or more users is received, via a user request module. Additionally, in another embodiment, upon approval of the request, a virtual environment may be generated, via a communication module.

In yet a further embodiment, the method may be comprised of a fifth step 1350, wherein one or more suggested group activities are created, via a suggestion algorithm.

In a sixth step 1360 of the method, said method may determine, via a connection algorithm, compatibility scores between a first user and one or more additional users.

Further, in a seventh step 1370, the method may be configured to display to the first user one or more indicators identifying one or more of, the one or more additional users associated with a compatibility score which is above a compatibility score threshold.

Moreover, in an eighth step, the method may send, via a smart invite algorithm, invites to one or more suggested users that are likely to attend the one or more hangouts, the invites corresponding to the one or more hangouts.

In an embodiment, the suggestion algorithm may be comprised of a machine learning algorithm. In such an embodiment, said machine learning algorithm may include a computer-implemented method. Such a computer implemented method may comprise the following steps: (1) receiving an input dataset, wherein the dataset may include at least one of a user's historical communication data and the user information; (2) predicting, the one or more suggested group activities, that one of the one or more users is likely to attend based on the input dataset; and (3) producing, an output dataset comprising the one or more suggested group activities, that one of the one or more users is likely to attend.

Moreover, the connection algorithm may be comprised of a machine learning algorithm, wherein said algorithm includes a computer implemented method comprising the steps of: (1) receiving an input dataset which may be comprised of user information of a plurality of user profiles; (2) determining a similarity between the user information of a first user and the user information of the one or more additional users; and (3) producing, an output dataset including the compatibility score of the first user and the one or more additional users.

In yet a further embodiment, the smart invite algorithm may be comprised of a machine learning algorithm, which may include a computer-implemented method comprising the steps of: (1) receiving an input dataset, which may include, user information of a plurality of user profiles; (2) predicting the one or more suggested users that are likely to attend the one or more hangouts; and (3) producing an output dataset comprising the one or more suggested users.

Furthermore, the present disclosure may be further described as a non-transitory computer readable medium having a set of instructions stored thereon that, when executed by a processing device, may cause the processing device to carry out an operation. In an embodiment, the aforementioned operation may be comprised of a first step, wherein in said first step, the operation receives, via a user profile module, a user profile. As a nonlimiting example, the user profile may include user information, wherein said information is comprised of at least one of one or more user interests, one or more user preferences, or membership to one or more private communities.

Moreover, the operation may be further comprised of a second step, wherein one or more hangouts are created, via a hangout creation module, based on the user information. In an example, the one or more hangouts include at least one of one or more public hangouts, one or more exclusive hangouts, or one or more private hangouts. In a further embodiment, the one or more exclusive hangouts may restrict a user's ability to join the one or more exclusive hangouts. In yet a further embodiment, each of the one or more private hangouts may be associated to one or more private communities. Moreover, the one or more private hangouts may also be configured to be accessible to users having membership to the one or more associated private communities.

A third step of the operation may include, displaying, via a display module, the one or more hangouts on a map interface. As a nonlimiting example, the map interface may be configured to display a geographical representation of an approximate location of the one or more hangouts.

Furthermore, the operation may be additionally comprised of a fourth step, wherein a request to join one of the one or more exclusive hangouts from one of the one or more users is received, via a user request module. Additionally, in another embodiment, upon approval of the request, a virtual environment may be generated, via a communication module.

In yet a further embodiment, the operation may be comprised of a fifth step, wherein one or more suggested group activities are created, via a suggestion algorithm.

In a sixth step of the operation, said operation may determine, via a connection algorithm, compatibility scores between a first user and one or more additional users. Further, in a seventh step, the operation may be configured to display to the first user one or more indicators identifying one or more of, the one or more additional users associated with a compatibility score which is above a compatibility score threshold. Moreover, in an eighth step, the operation may send, via a smart invite algorithm, invites to one or more suggested users that are likely to attend the one or more hangouts, the invites corresponding to the one or more hangouts.

In an embodiment, the suggestion algorithm may be comprised of a machine learning algorithm. In such an embodiment, said machine learning algorithm may include a computer-implemented method. Such a computer implemented method may comprise the following steps: (1) receiving an input dataset, wherein the dataset may include at least one of a user's historical communication data and the user information; (2) predicting, the one or more suggested group activities, that one of the one or more users is likely to attend based on the input dataset; and (3) producing, an output dataset comprising the one or more suggested group activities, that one of the one or more users is likely to attend.

Furthermore, the connection algorithm may be comprised of a machine learning algorithm, wherein said algorithm includes a computer implemented method comprising the steps of: (1) receiving an input dataset which may be comprised of user information of a plurality of user profiles; (2) determining a similarity between the user information of a first user and the user information of the one or more additional users; and (3) producing, an output dataset including the compatibility score of the first user and the one or more additional users.

In yet a further embodiment, the smart invite algorithm may be comprised of a machine learning algorithm, which may include a computer-implemented method comprising the steps of: (1) receiving an input dataset, which may include, user information of a plurality of user profiles; (2) predicting the one or more suggested users that are likely to attend the one or more hangouts; and (3) producing an output dataset comprising the one or more suggested users.

A number of implementations have been described. Nevertheless, it will be understood that various modifications may be made without departing from the spirit and scope of the disclosure. Accordingly, other implementations are within the scope of the following claims.

The instant invention is a method for enhancing social interaction and community building, comprising:
a. receiving a user profile;
b. creating a hangout based on the user profile;
c. displaying the hangout;
d. receiving a request from a user to join the hangout; and
e. enabling communication within the hangout upon approval of the user request.

The instant invention can further comprise the step of suggesting group activities based on common interests identified in the user profile.

The instant invention, wherein the group activities are suggested by an algorithm.

The instant invention, further comprising the step of enabling a user to invite other users to join the hangout.

The instant invention, wherein the other users are selected based on their proximity to the user or their membership in a specific team.

The instant invention, further comprising the step of automatically creating a chat for the hangout.

The instant invention, wherein the hangout is displayed on a map interface.

The instant invention can also be described as a system for enhancing social interaction and community building, comprising:
a. a user profile module configured to receive a user profile;
b. a hangout creation module configured to create a hangout based on the user profile;
c. a display module configured to display the hangout;
d. a user request module configured to receive a request from a user to join the hangout; and
e. a communication module configured to enable communication within the hangout upon approval of the user request.

The instant invention, wherein the user profile module is further configured to receive user interests and preferences.

The instant invention, wherein the hangout creation module is further configured to suggest group activities based on the user interests and preferences.

The instant invention, wherein the suggested group activities are displayed on the display module.

The instant invention, wherein the user request module is further configured to receive a request from a user to invite other users to join the hangout.

The instant invention, wherein the other users are selected based on their proximity to the user or their membership in a specific team.

The instant invention, wherein the communication module is further configured to automatically create a chat for the hangout.

The instant invention can also be described as a non-transitory computer-readable medium storing instructions that, when executed by a processor, cause the processor to perform a method for enhancing social interaction and community building, the method comprising:
a. receiving a user profile;
b. creating a hangout based on the user profile;
c. displaying the hangout;
d. receiving a request from a user to join the hangout; and
e. enabling communication within the hangout upon approval of the user request.

The instant invention can also include a non-transitory computer-readable medium, wherein the user profile includes user interests and preferences.

The instant invention can also include a non-transitory computer-readable medium, wherein the hangout is created based on the user interests and preferences.

The instant invention can also include a non-transitory computer-readable medium, wherein the hangout includes group activities suggested based on the user interests and preferences.

The instant invention can also include a non-transitory computer-readable medium, wherein the group activities are displayed on a map interface.

The instant invention can also include a non-transitory computer-readable medium, wherein the communication within the hangout includes an automatically created chat for the hangout.

Referring now to the drawings FIG. 3-8, and more particularly to FIG. 3, there is shown a flow chart showing how a user would use the system.
a. Step 302 is where the user generates the Hangout in the application.
b. Step 304 is where the user displays the Hangout in the application.
c. Step 306 is where the application receives the user profile.
d. Step 308 is where the application applies to join the hangout. If they do not join the application transfers of control to step 314.
e. If they do join the hangout then control is transferred to step 310 where the application sends a request to the organizer to approve the user.
f. If the organizer approves the user, the application transfers control to step 312 where the application provides the location of the Hangout and allows the user to communicate with the application and Hangout.
g. Step 314 is where the application does not allow the user to join and does not allow the user to communicate with the application.

FIG. 4 is a flow chart showing how the organizer of the hangout would use the system.
a. Step 402 the organizer creates the hangout in the application.
b. Step 404 the organizer invites other users. If they invite other users, then the application transfers control to step 406. If they do not invite other users, the application transfers control to step 412.
c. Step 22 the application displays categories of users.
d. Step 408 the organizer can select users.
e. Step 410 the application notifies the selected users and displays the hangout in step 414.
f. Step 416 the users that have been notified in step 410 accepts the invitation and the application transfers control to step 422.
g. Step 412 is where an uninvited user can request the application to join the hangout.
h. Step 420 the organizer approves the user from step 418 request to join the hangout and the application transfers control to step 422. If the organizer does not approve the user from step 418 the application transfers control to step 424.
i. Step 424 the application does not show the location or allow communication.
j. Step 422 the application allows communication and shows the location of the hangout to the user.

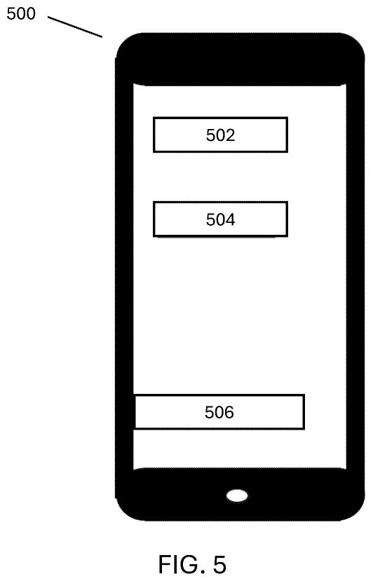

FIG. 5 is a screenshot 500 of the mobile application showing how a user creates a profile. Item 502 is users name and information; item 504 is the user interest and activities and 525 is the menu with home and other navigation tools. The user can include as much or as little information as they want, but the more the system reminds them that the more you include the easier it will be to find the friends you like.

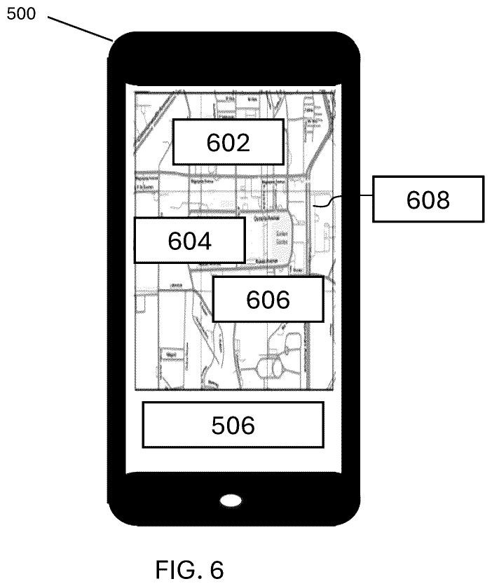

FIG. 6 is a screenshot 600 of the mobile application showing how a user creates a hangout and check out other hangouts. Hangouts 602, 604 and 606 are displayed on map 608. Item 506 is the menu with home and other navigation tools. The navigation allows the user to check out other hangouts and investigate other user hangouts in which they are interested in. The user can retrieve details using the detail button to display the hangout information.
a. Hangout with an existing friend.
b. Hangout with a suggested friend.

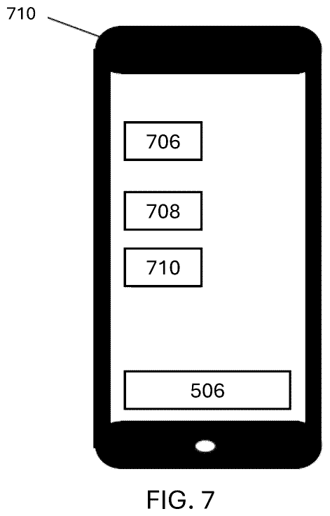

FIG. 7 is a screen shot of 750 of the mobile application showing a hangout 708 and how to check who's going to a hangout 710. If the user wants to apply to go to a hangout, they apply 780 and the organizer is notified. If the organizer approves, then the application sends the exact location and time. Item 506 is the menu with home and other navigation tools.

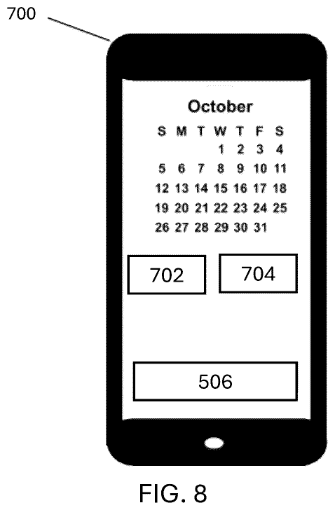

FIG. 8 is a screenshot 700 of the mobile application showing how to create a hangout and select the activity that the user wants to do. The initial step is to select a date from calendar 702 and the application displays a list of events or hangouts 704 and your identity information 706. Item 506 is the menu with home and other navigation tools.

The calendar 702 may show suggested dates and times based on the predicted availability of users within the organizing user's communities, or users predicted to be likely to want to attend the hangout.

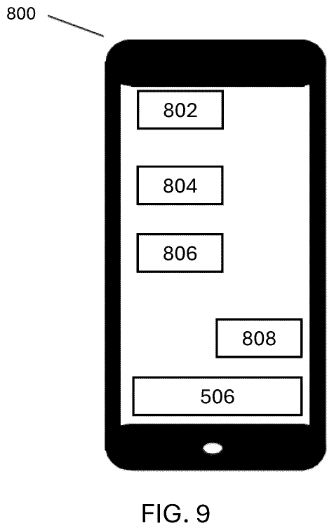

FIG. 9 is a screenshot of the mobile application 800 showing how a user can look up new members and chat with other members of a hangout; the user can use link 802 to find new members, link 804 is used to select members to initiate a chat with and item 806 the chat field and item 808 allows the user to add a new friend. Item 506 is the menu with home and other navigation tools.

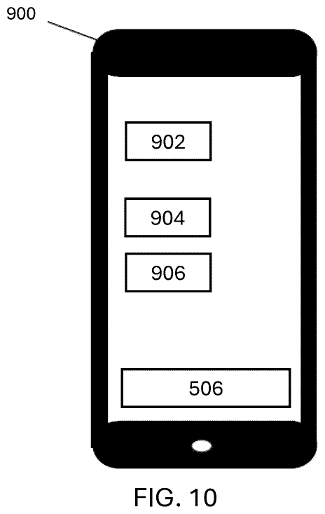

FIG. 10 is a screenshot 700 of the mobile application showing how a user can add new friends to create a custom circle 704 of friends within hangout or look up existing friends 706 and add them to the circle or hangout. Item 506 is the menu with home and other navigation tools.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for identifying and facilitating virtual communication and networking, the system comprising:
a device comprising at least one device processor, at least one device database, at least one device memory comprising computer-executable device instructions which, when executed by the at least one device processor, cause the device to:
receive a user profile, via a user profile module,
the user profile including user information,
wherein the user information is comprised of at least one of one or more user interests, one or more user preferences, or membership to one or more private communities;
create, via a hangout creation module, one or more hangouts based on the user information,
wherein the one or more hangouts include at least one of one or more public hangouts, one or more exclusive hangouts, or one or more private hangouts,
wherein the one or more exclusive hangouts restrict a user's ability to join the one or more exclusive hangouts,
wherein each of the one or more private hangouts are associated to one or more private communities, and
wherein the one or more private hangouts are configured to be accessible to users having membership to the one or more associated private communities or users invited to the one or more private hangouts by an organizing user;
display, via a display module, the one or more hangouts on a map interface,
wherein the map interface is configured to display a geographical representation of an approximate location of the one or more hangouts;
receive, via a user request module, a request to join one of the one or more exclusive hangouts from one of the one or more users,
upon approval of the request, generating a virtual environment, via a communication module;
create, via a suggestion algorithm, one or more suggested group activities;
determine, via a connection algorithm, compatibility scores between a first user and one or more additional users; and
display to the first user one or more indicators identifying one or more of, the one or more additional users associated with a compatibility score which is above a compatibility score threshold.

2. The system of claim 1, wherein the suggestion algorithm is a machine learning algorithm including a computer-implemented method comprising:
receiving an input dataset including,
at least one of a user's historical communication data and the user information;
predicting, the one or more suggested group activities, that one of the one or more users is likely to attend based on the input dataset; and
producing, an output dataset comprising the one or more suggested group activities, that one of the one or more users is likely to attend.

3. The system of claim 1, wherein the connection algorithm is a machine learning algorithm including a computer-implemented method comprising:
receiving an input dataset including,
user information of a plurality of user profiles;
determining a similarity between the user information of a first user and the user information of the one or more additional users; and
producing, an output dataset including the compatibility score of the first user and the one or more additional users.

4. The system of claim 1, wherein the virtual environment is a chat facilitating real-time communication amongst the one or more users.

5. The system of claim 1, wherein the one of one or more user interests and one or more user preferences include at least one of: outdoor activities, indoor activities, sports, religion, and education.

6. The system of claim 1, wherein the computer-executable device instructions which, when executed by the at least one device processor, further cause the device to:
send, via a smart invite algorithm, invites to one or more suggested users that are likely to attend the one or more hangouts, the invites corresponding to the one or more hangouts.

7. The system of claim 6, wherein the smart invite algorithm is a machine learning algorithm including a computer-implemented method comprising:
receiving an input dataset including,
user information of a plurality of user profiles;
predicting the one or more suggested users that are likely to attend the one or more hangouts; and
producing an output dataset comprising the one or more suggested users.

8. The system of claim 1, wherein the computer-executable device instructions which, when executed by the at least one device processor, further cause the device to:
enable, via a contextual invite system, a first user to invite a second user to join one of the one or more hangouts.

9. The system of claim 8, wherein the contextual invite system is based on at least one of a proximity to the first user and a community membership of the second user.

10. A computer-implemented method for identifying and facilitating virtual communication and networking, wherein each of the following steps are performed by one or more computer components, the computer-implemented method comprising:
receiving, via a user profile module, a user profile,
the user profile including user information,
wherein the user information is comprised of at least one of one or more user interests, one or more user preferences, or membership to one or more private communities;
creating, via a hangout creation module, one or more hangouts based on the user information,
wherein the one or more hangouts include at least one of one or more public hangouts, one or more exclusive hangouts, or one or more private hangouts,
wherein the one or more exclusive hangouts restrict a user's ability to join the one or more exclusive hangouts,
wherein each of the one or more private hangouts are associated to one or more private communities, and
wherein the one or more private hangouts are configured to be accessible to users having membership to the one or more associated private communities or users invited to the one or more private hangouts by an organizing user;
displaying, via a display module, the one or more hangouts on a map interface, wherein the map interface is configured to display a geographical representation of an approximate location of the one or more hangouts;
receiving, via a user request module, a request to join one of the one or more exclusive hangouts from one of the one or more users,
upon approval of the request, generating a virtual environment, via a communication module;
creating, via a suggestion algorithm, one or more suggested group activities;
determining, via a connection algorithm, compatibility scores between a first user and one or more additional users; and
displaying to the first user one or more indicators identifying one or more of, the one or more additional users associated with a compatibility score which is above a compatibility score threshold.

11. The computer-implemented method of claim 10, wherein the suggestion algorithm is a machine learning algorithm including a computer-implemented method comprising:
receiving an input dataset including,
at least one of a user's historical communication data and the user information;
predicting, the one or more suggested group activities, that one of the one or more users is likely to attend based on the input dataset; and
producing, an output dataset comprising the one or more suggested group activities, that one of the one or more users is likely to attend.

12. The computer-implemented method of claim 10, wherein the connection algorithm is a machine learning algorithm including a computer-implemented method comprising:
receiving an input dataset including,
user information of a plurality of user profiles;
determining a similarity between the user information of a first user and the user information of the one or more additional users; and
producing, an output dataset including the compatibility score of the first user and the one or more additional users.

13. The computer-implemented method of claim 10, further comprising:
sending, via a smart invite algorithm, invites to one or more suggested users that are likely to attend the one or more hangouts, the invites corresponding to the one or more hangouts.

14. The computer-implemented method of claim 13, wherein the smart invite algorithm is a machine learning algorithm including a computer-implemented method comprising:
receiving an input dataset including,
user information of a plurality of user profiles;
predicting the one or more suggested users that are likely to attend the one or more hangouts; and
producing an output dataset comprising the one or more suggested users.

15. A non-transitory computer readable medium having a set of instructions stored thereon that, when executed by a processing device, cause the processing device to carry out an operation, the operation comprising the steps of:
receiving, via a user profile module, a user profile,
the user profile including user information,
wherein the user information is comprised of at least one of one or more user interests, one or more user preferences, or membership to one or more private communities;
creating, via a hangout creation module, one or more hangouts based on the user information,
wherein the one or more hangouts include at least one of one or more public hangouts, one or more exclusive hangouts, or one or more private hangouts,
wherein the one or more exclusive hangouts restrict a user's ability to join the one or more exclusive hangouts,
wherein each of the one or more private hangouts are associated to one or more private communities, and
wherein the one or more private hangouts are configured to be accessible to users having membership to the one or more associated private communities or users invited to the one or more private hangouts by an organizing user;
displaying, via a display module, the one or more hangouts on a map interface,
wherein the map interface is configured to display a geographical representation of an approximate location of the one or more hangouts;
receiving, via a user request module, a request to join one of the one or more exclusive hangouts from one of the one or more users,
upon approval of the request, generating a virtual environment, via a communication module;
creating, via a suggestion algorithm, one or more suggested group activities;
determining, via a connection algorithm, compatibility scores between a first user and one or more additional users; and
displaying to the first user one or more indicators identifying one or more of, the one or more additional users associated with a compatibility score which is above a compatibility score threshold.

16. The non-transitory computer readable medium of claim 15, wherein the suggestion algorithm is a machine learning algorithm including a computer-implemented method comprising:
receiving an input dataset including,
at least one of a user's historical communication data and the user information;
predicting, the one or more suggested group activities, that one of the one or more users is likely to attend based on the input dataset; and
producing, an output dataset comprising the one or more suggested group activities, that one of the one or more users is likely to attend.

17. The non-transitory computer readable medium of claim 15, wherein the connection algorithm is a machine learning algorithm including a computer-implemented method comprising:
receiving an input dataset including,
user information of a plurality of user profiles;
determining a similarity between the user information of a first user and the user information of the one or more additional users; and
producing, an output dataset including the compatibility score of the first user and the one or more additional users.

18. The non-transitory computer readable medium of claim 15, further comprising the step of:
sending, via a smart invite algorithm, invites to one or more suggested users that are likely to attend the one or more hangouts, the invites corresponding to the one or more hangouts.

19. The non-transitory computer readable medium of claim 18, wherein the smart invite algorithm is a machine learning algorithm including a computer-implemented method comprising:
receiving an input dataset including,
user information of a plurality of user profiles;
predicting the one or more suggested users that are likely to attend the one or more hangouts; and
producing an output dataset comprising the one or more suggested users.

20. The non-transitory computer readable medium of claim 15, wherein the virtual environment is a chat facilitating real-time communication amongst the one or more users.
